(19) United States
(12) Patent Application Publication
(10) Pub. No.: US 2005/0018553 A1
(43) Pub. Date: Jan. 27, 2005

(54) Supporting member for an optical pick-up actuator, and optical pick-up actuator and optical recording/reproducing apparatus using the same

(75) Inventors: Hyung-joo Kang, Seoul (KR); Jong-ha Joen, Suwon-si (KR); Won-ik Cho, Seoul (KR); Byung-youn Song, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/896,008

(22) Filed: Jul. 22, 2004

(30) Foreign Application Priority Data
Jul. 24, 2003 (KR) 2003-51102

(51) Int. Cl. G11B 7/00

(52) U.S. Cl. 369/44.15; 369/44.22

(57) ABSTRACT

A supporting member, an optical pick-up actuator that employs a plurality of supporting members, and an optical recording and/or reproducing apparatus using the optical pick-up actuator. The supporting members have a wire pattern to apply a current, and are combined with a bobbin on which an objective lens is mounted. The optical pick-up actuator actuates the bobbin by a magnetic actuating unit, wherein the bobbin is suspended by the supporting members.

### CROSS-REFERENCE TO RELATED APPLICATIONS

This application claims the priority of Korean Patent Application No. 2003-51102, filed on Jul. 24, 2003, in the Korean Intellectual Property Office, the disclosure of which is incorporated herein in its entirety by reference.

### BACKGROUND OF THE INVENTION

1. Field of the Invention

The present invention relates to a supporting member of an optical pick-up apparatus having a reduced number of parts, and an optical pick-up actuator and an optical recording and/or reproducing apparatus using the supporting member.

2. Description of the Related Art

Generally, an optical pick-up device is an apparatus used to record and/or reproduce information on and from an optical disc placed on a turn table in a recording/reproducing apparatus, by moving in a non-contact manner along a radial direction of the optical disc.

The optical pick-up device includes an objective lens that forms an optical spot on the optical disc by collecting light emitted from a light source, and an actuator that controls the location of the optical spot in a focus direction and a tilt direction relative to the track of the optical disc.

Usually, the actuator is a two-axis actuator controlling a position of the optical spot in the focus direction and the tilt direction. But an aperture member tilt margin of the optical pick-up actuator is reduced according to a wavelength reduction of a laser, a wavelength of the lens, and an increment of a number of the objective lens for high-density recording. Thus, for high density recording, a three-axis actuator or a four-axis actuator that can compensate the tilt margin is needed. The three-axis actuator controls the location of the optical spot in a focus direction, a track direction, and a tilt radial direction. In addition to these directions, the four-axis actuator also controls the location of the optical spot in a tilt tangential direction. Referring to FIG. 1, L-L′ is the focus direction, M-M′ is the track direction, N is the tilt radial direction, and 0 is the tilt tangential direction.

FIG. 1 is a plan view of a conventional optical pick-up actuator.

Referring to FIG. 1, the conventional optical pick-up actuator comprises a base 100, a holder 103 fixed on the base 100, a bobbin 107 on which an objective lens 105 is loaded, wires 109 that connect the bobbin 107 to the holder 103, and a magnetic driving unit that moves the bobbin 107 in the focus direction, in the track direction, and in the tilt radial direction.

The magnetic driving unit comprises a pair of focus coils 110 each of which being respectively disposed on surfaces 107a facing each other, a pair of tilt coils 112 (see FIG. 2A), each of which being disposed on the surfaces 107a facing each other, in parallel with the focus coils 110, a pair of track coils 115 each of which being respectively disposed on surfaces 107b adjacent to the surfaces 107a, and first and second magnets 117 and 119 disposed on the base 100, respectively facing the focus coils 110 and the tilt coils 112, and the track coil 115, at predetermined distances from the focus coils 110 and the tilt coils 112, and the track coil 115. The magnetic driving unit further comprises outer yokes 118 and 120 that respectively fix the first magnets 117 and the second magnets 119 disposed on the base 100, and inner yokes 122 that guide the bobbin 107, disposed on locations facing the first magnets 117 on the base 100. The outer yokes 118 and 120 and the inner yokes 122 are devices for guiding magnetic flux by the first and the second magnets 117 and 119.

The wires 109 are electrically connected to a circuit unit that applies current to the magnetic driving unit, one end of each of the wires 109 being connected to a respective side of the bobbin 107 by soldering and the other end of each of the wires 109 being connected to the holder 103.

FIG. 2A is a schematic drawing showing the polarity of the first magnet 117 and the direction of the current through the coils 110 and 112 to explain interaction between the focus coils 110 and tilt coils 112 and the first magnets. The focus coils 110 on two sides 107a move the bobbin 107 in the focus direction L by the electromagnetic force Ff according to the Fleming's left hand rule. When the current I direction is reversed, the focus coils 110 move in a counter direction L′.

When currents through the coils 110 and 112 have equal magnitudes but opposite directions, the bobbin 107 is actuated in the tilt direction, especially, in the radial tilt direction N since the forces Fti applied to both ends of the tilt coils 112 are in opposite directions from each other.

FIG. 2B is a schematic drawing showing the polarity of second magnets 119 and a direction of a current through the track coils 115 to explain force interaction between the track coils 115 and the second magnets 119 corresponding to the track coils 115. The direction and magnitude of force between the second magnets 119 and the track coils 115 are determined by Fleming's left hand rule. Therefore, the track coil 115 moves the bobbin 107 in the track direction M by the force Ft applied to the track coil 115 by the second magnet 119. When the direction of the current I through the track coils 115 is reversed, the track coils 115 are forced to move in a counter direction M′.

To actuate in three directions, i.e., the focus direction, the track direction, and the tilt direction, conventionally, six wires 109 are used. When actuating in four directions, the actuator requires more wires 109. However, when a large number of wires are included in a small space, the mounting process may become very difficult and complicated, and require an increased labor cost, thereby reducing yield, increasing a failure rate, and inhibiting miniaturization of the actuator.

### SUMMARY OF THE INVENTION

To solve the above and/or other problems, the present invention provides a supporting member with a wire pattern, which can be manufactured with reduced labor cost and high productivity, and an optical pick-up actuator and an optical recording and/or reproducing apparatus that employs the supporting member.

According to an embodiment of the present invention, there is provided a supporting member that supports a moving bobbin on which an objective lens is mounted, the supporting member having a wire pattern to apply a current.

According to one aspect, the wire pattern is made of PCB.

According to one aspect, the supporting member has a spiral shape.

According to an embodiment of the present invention, there is provided an optical pick-up actuator actuating a bobbin, on which an objective lens is mounted, by a magnetic actuator, wherein the bobbin is suspended by a plurality of supporting members, each supporting member having a wire pattern to apply a current.

According to an embodiment of the present invention, there is provided an optical recording/reproducing apparatus that records and/or reproduces information on/from an optical disc by moving a bobbin on which an objective lens is mounted with respect to the optical disc, wherein the bobbin is suspended by a plurality of supporting members, each supporting member having a wire pattern to apply a current.

Additional aspects and/or advantages of the invention will be set forth in part in the description which follows, and in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a plan view of a conventional optical pick-up actuator;

FIGS. 2A and 2B are schematic drawings showing an operation of a magnetic driving unit employed in the conventional optical pick-up actuator of FIG. 1;

FIG. 3 is a perspective view of an optical pick-up actuator combined with supporting members according to an embodiment of the present invention;

FIG. 4 is a photograph showing a simulation result of rigidity of supporting members according to an embodiment of the present invention;

FIG. 5 is an exploded perspective view of an optical pick-up actuator according to an embodiment of the present invention;

FIGS. 6 and 7 are plan views of a magnetic driving unit according to an embodiment of the present invention;

FIG. 8 is an exploded perspective view of another optical pick-up actuator according to an embodiment of the present invention;

FIG. 9 is a schematic drawing of a recording and/or reproducing apparatus according to an embodiment of the present invention.

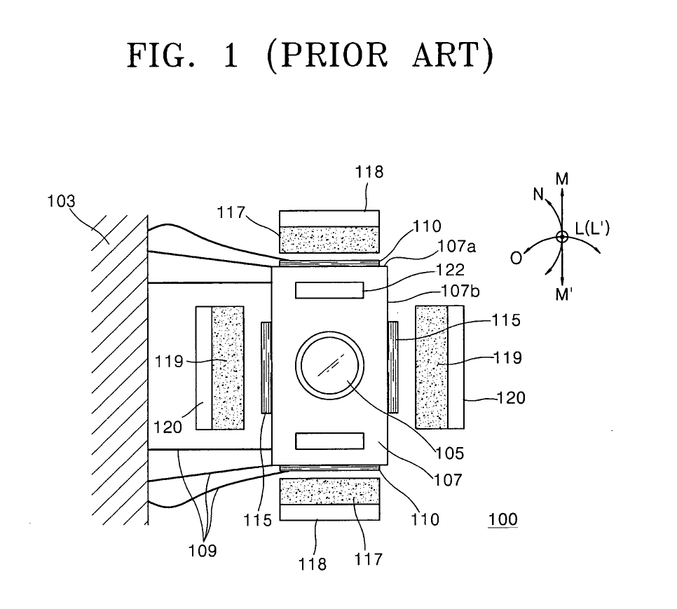

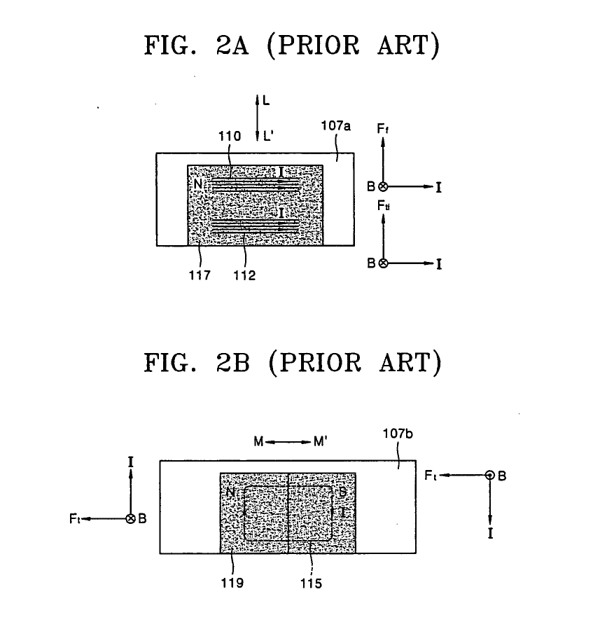

### DETAILED DESCRIPTION

Reference will now be made in detail to the embodiments of the present invention, examples of which are illustrated in the accompanying drawings, wherein like reference numerals refer to the like elements throughout. The embodiments are described below to explain the present invention by referring to the figures.

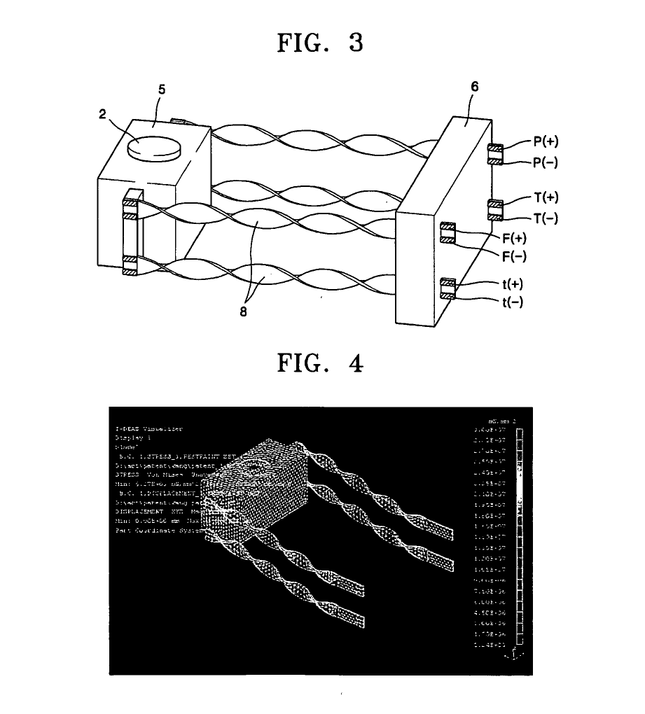

Referring to FIG. 3, an optical pick-up actuator according to an embodiment of the present invention comprises a bobbin 5 on which an objective lens 2 is mounted, and at least one supporting member 8 (four are shown in the drawing), a first end of which is combined with the bobbin 5, and a second end of which is connected to a holder 6. A magnetic driving unit to actuate the bobbin 5 in a track direction, a focusing direction, and a tilt direction is not shown.

Each supporting member 8 has a wire pattern having a spiral shape. That is, each supporting member 8 has a wire pattern made of a non-conductive material. Respective end parts of each wire of the supporting members 8 are attached to the holder 6 and the bobbin 5 by soldering.

According to one embodiment, the wire pattern is made of PCB (Printed Circuit Board), and has at least one wire. If necessary, a number of the supporting members 8 is minimized by forming a pattern that includes a plurality of wires. For example, according to one embodiment, a (+) focusing wire F(+) and a (−) focusing wire F(−) are formed into one supporting member, a (+) tracking wire T(+) and a (−) tracking wire T(−) are formed into one supporting member, and a (+) tilt wire t(+) and a (−) tilt wire t(−) are formed into one supporting member. When additional wires for other purposes are required, a supporting member having one wire pattern is formed. For example, wires P(+) and P(−) for driving an LCD (Liquid Crystal Display) may further be formed. In this manner, an overall number of the supporting members 8 can be reduced by forming a given supporting member with a plurality of wire patterns.

To actuate an optical pick-up actuator in focusing, tracking, and tilting directions, at least six wires are required when using conventional wires. If additional wires for other purposes are required, at least eight wires are used. But when the supporting member having wire patterns according to an embodiment of the present invention is used, the number of the supporting members 8 is reduced to four.

According to one embodiment, the supporting member 8 is a board in which a first side of a cross-unit of the supporting member is longer than a second side. When a width and a length of the cross-unit are different, a rigidity of the supporting member 8 varies according to a moving direction of the supporting member 8. Since sensitivity according to the rigidity of the supporting member 8 is large, if the rigidity is different in each direction, the precise control in the focusing, tracking, and tilt directions becomes very difficult. Thus, according to one embodiment, the supporting member 8 has a spiral shape, to have rigidity in all directions regardless of the actuating directions. The spiral shape supporting member 8 shows uniform rigidity on an overall body of the supporting member 8. FIG. 4 is a photograph showing a simulation result of rigidity of a supporting member according to an embodiment of the present invention. The degrees of the rigidity of the supporting member 8 are shown in different colors, and the overall color of the supporting member 8 is very similar to each other.

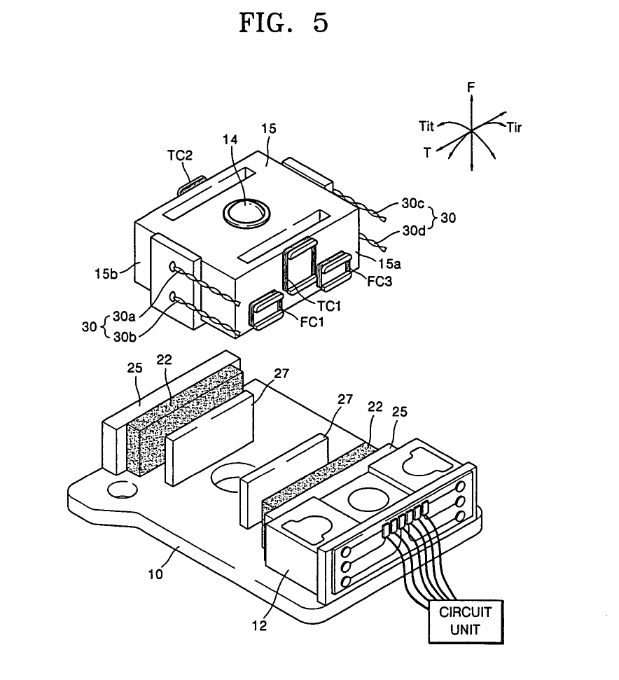

FIG. 5 is an optical pick-up actuator according to an embodiment of the present invention.

Referring to FIG. 5, the optical pick-up actuator comprises a base 10, a holder 12 disposed on a side on the base 10, a bobbin 15 on which an objective lens 14 is mounted, and a magnetic driving unit that actuates the bobbin 15 in a focus direction, a tilt direction, and a track direction. Also, at least one supporting member 30 is combined between the holder 12 and the bobbin 15.

The magnetic driving unit includes at least one focus coil to actuate in a focus direction, at least one track coil to actuate in a track direction, at least one tilt coil to actuate in a tilt direction, and magnets 22 facing the focus coil, the track coil, and the tilt coil.

For example, according to one embodiment, the focus coil includes first, second, third, and fourth focus coils FC1, FC2, FC3, and FC4, and the track coil includes two track coils TC1 and TC2. The first, second, third, and fourth focus coils FC1, FC2, FC3, and FC4 are commonly used for focus actuating and tilt actuating. Also, the magnets 22 with the bobbin 15 therebetween are disposed facing the first, second, third, and fourth focus coils FC1, FC2, FC3, and FC4, two track coils TC1 and TC2, and the tilt coil.

The first, second, third, and fourth focus coils FC1, FC2, FC3, and FC4, and the two track coils TC1 and TC2 are all disposed on opposing side surfaces 15a of the bobbin 15, and the supporting members 30 applying current to the first, second, third, and fourth focus coils FC1, FC2, FC3, and FC4 and the two track coils TC1 and TC2 are disposed on the opposing side surfaces 15b, adjacent the sides 15a on which the coils are disposed.

As is described above, the supporting members 30 have a wire pattern. According to one embodiment, when each supporting member 30 includes two wires, three supporting members 30a, 30b, and 30c are provided for focusing actuating, tracking actuating, and tilt actuating, and if a plurality of wires for LCD actuating are required, then a fourth supporting member 30d is added. The LCD actuating is required for compensating for a spherical aberration caused by a thickness difference of layers when using a dual layer disc. When installing the LCD on the bobbin, a plurality of wires are required for LCD actuating.

If the wires for LCD actuating are added, there are at least eight wires including the wires for focus actuating, tracking actuating, and tilt actuating. For example, when eight wires are required, four supporting members, each including two wire patterns, can be formed. According to one embodiment, when nine wires are required, first, second, and third supporting members, each including two wire patterns are used, and a fourth supporting member, in which two wire patterns are positioned on a first side of the fourth supporting member and one wire pattern is positioned on a second side of the fourth supporting member, is used.

Alternately, as is illustrated in the embodiment depicted in FIG. 5, when requiring wires only for focus actuating, tracking actuating, and tilt actuating, and when using wires for focusing actuating and the tilt actuating in common, the four wires for the first, second, third, and fourth focus coils FC1, FC2, FC3, and FC4 are included in the first supporting member 30a and the second supporting member 30b, with two wire patterns in each supporting member. And the wires for the track coils TC1 and TC2 are included in the third and fourth supporting members 30c and 30d with a single wire pattern in each of the supporting members 30c and 30d.

In the above configuration, the first, second, third, and fourth focus coils FC1, FC2, FC3, and FC4 control the bobbin to move in both the focus direction and the tilt direction.

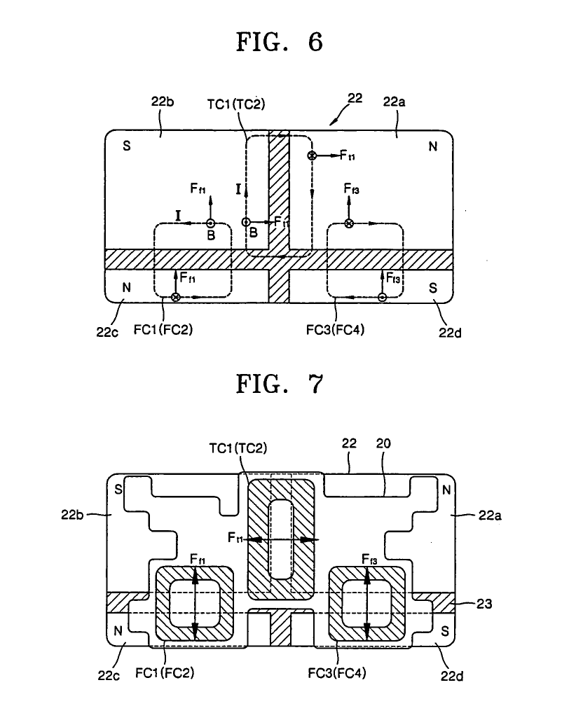

FIG. 6 is plan view of a magnetic driving unit according to an embodiment of the present invention.

Referring to FIG. 6, the magnet 22 has four polarized regions. That is, according to one embodiment, the magnet 22 is divided into four polarizations (or polarized regions) on which N pole and S pole are distributed. For convenience, the four polarized regions of the magnet 22 are designated as a first polarization 22a (N pole), a second polarization 22b (S pole), a third polarization 22c (N pole), and a fourth polarization 22d (S pole). The focus coils FC1, FC2, FC3, and FC4 and the track coils TC1 and TC2 are disposed corresponding to each of the polarizations 22a, 22b, 22c, and 22d of the magnet 22.

For example, the track coils TC1 and TC2 are disposed covering both the first polarization 22a and the second polarization 22b facing each other. The focus coils FC1, FC2, FC3, and FC4 are disposed in pairs on each side surface 15a of the bobbin 15 on which the track coils TC1 and TC2 are disposed. For example, the third and fourth focus coils FC3 and FC4 are disposed covering the first polarization 22a and the fourth polarization 22d on opposing sides 15a of the bobbin 15. Similarly, the first and second focus coils FC1 and FC2 are disposed covering the second polarization 22b and the third polarization 22c on opposing sides 15a of the bobbin 15.

On the other hand, according to one embodiment, the magnet 22 is a surface polarization magnet having two polarized regions. For example, a set of surface polarization magnets which includes two surface polarization magnets can be disposed facing the focus coils FC1, FC2, FC3, and FC4 and the track coils TC1 and TC2 by a predetermined distance.

According to one embodiment, the focus coils FC1, FC2, FC3, and FC4 and the track coils TC1 and TC2 are winding coils. As is depicted in FIG. 7, at least one of the focus coil, the tilt coil, and the track coil is a fine pattern coil 20. The fine pattern coil 20 is manufactured by patterning a coil type on a film, and is easily mounted in a very narrow space.

The above embodiment is the case that the tilt coil is commonly used as the focus coils FC1, FC2, FC3, and FC4. That is, one coil controls actuation of the bobbin 15 in the focus direction and the tilt direction.

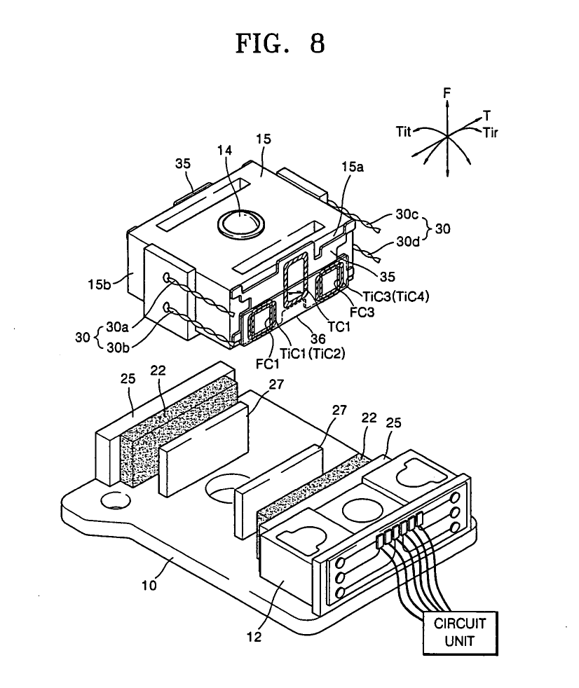

The tilt coils however, according to another embodiment, are provided independently from the focus coils. As is depicted in FIG. 8, the first through the fourth tilt coils TiC1, TiC2, TiC3, and TiC4, and the first through the fourth focus coils FC1, FC2, FC3, and FC4 are disposed overlapping in similar locations. These coils are disposed in first and second fine pattern coils 35 and 36.

When the focusing coils, the tilt coils, and the track coils are actuated independently, at least two wires are required to apply power to the focusing coils. Also, to apply power to the tilt coils and the track coils, four wires are required. In such a case, when six wires are required, two supporting members, each including two wire patterns can be used, and two supporting members, each including one wire pattern can be used. Then, a supporting member that includes two wire patterns and a supporting member that includes a wire pattern can be disposed on each side 15b of the bobbin 15.

According to embodiments of the present invention, the use of supporting members reduces the labor cost for fabricating the actuator. Also, use of the supporting members allows miniaturization of the actuator. The description about the disposition of the magnets and the coils of the present invention is exemplary, and accordingly, it can be modified to a variety of different forms without departing from the spirit of the present invention.

As is described above, the magnets 22 can have four polarization polarized regions 22a, 22b, 22c, and 22d, and the focus coils FC1, FC2, FC3, and FC4 are disposed in pairs on each side surface of the bobbin 15 in which FC3 and FC4 are crossing the first polarization 22a and the fourth polarization 22d facing each other, and FC1 and FC2 are crossing the second polarization 22b and the third polarization 22c facing each other. The second fine pattern coil 36, on which the first through the fourth tilt coils TiC1, TiC2, TiC3, and TiC4 are patterned, is disposed on a front face or rear face of the first fine pattern coil 35, on which the focus coils FC1, and FC3, and the track coil TC1 are patterned. The first through the fourth tilt coils TiC1, TiC2, TiC3, and TiC4 can be paired and disposed as such on each side 15a of the bobbin 15. In contrast, in FIG. 7, the first and the third tilt coils TiC1 and TiC3 are shown on a side 15a of the bobbin 15 but the second and the fourth tilt coils TiC2 and TiC4 are disposed on an opposite side 15a of the bobbin, from the side 15a on which the first and the third tilt coils TiC1 and TiC3 are disposed.

The magnets 22 are divided into the four polarization polarized regions 22a, 22b, 22c, and 22d with symmetrical polarization areas, but the first polarization polarized region 22a and the second polarization polarized region 22b, corresponding to the track coils, are polarized in a wider area than the third polarization polarized region 22c and the fourth polarization polarized region 22d, to secure an effective area of the track coils TC1 and TC2. That is, to balance the distribution of the polarized area between the tilt coils TiC1, TiC2, TiC3, and TiC4 and the focus coils FC1, FC2, FC3, and FC4, the polarized area can be adjusted because the focus coils FC1, FC2, FC3, and FC4 and the tilt coils TiC1, TiC2, TiC3, and TiC4 use all four polarization polarized regions 22a, 22b, 22c, and 22d, but the track coils TiC1 and TiC2 only use the first polarization polarized region 22a and the second polarization polarized region 22b.

Neutral zones, as is shown in FIG. 7, 23 can be positioned between each of the polarization polarized regions 22a, 22b, 22c, and 22d. The neutral zones 23 are positioned on boundaries between the polarization areas to avoid weakening of an overall magnetic force by offsetting magnetic lines at the interface regions where two different polarizations meet.

According to one embodiment, the optical pick-up actuator further comprises outer yokes 25 and inner yokes 27 to induce magnetic lines generated from the magnets 22 to a desired direction.

Operations of the optical pick-up actuator according to an embodiment of the present invention will now be described.

An embodiment in which the focus coils and the tilt coils are used in common will be described. In other words, by the interaction between the focus coils FC1, FC2, FC3, and FC4 and the magnets 22, actuations in the focus direction and the tilt direction are performed.

The actuating direction is determined according to the direction of the current applied to the focus coils FC1, FC2, FC3, and FC4. As a method of applying a current to the focus coils to actuate the bobbin 15, the current is applied to the first and the second focus coils FC1 and FC2, and another current is applied to the third and the fourth focus coils FC3 and FC4. Alternatively, each current can be applied to each of the focus coils FC1, FC2, FC3, and FC4.

In the former case, the first and the fourth coils FC1 and FC4 exert forces in the same direction, i.e., upward or downward, by the interaction with the magnets 22. Accordingly, the actuation of the bobbin 15 is controlled in the focus direction. In the latter case, left side and right side of the focus coils are forced in different directions, i.e., upward or downward, from each other. Accordingly, the actuation of the bobbin 15 is controlled in the tilt direction. Therefore, it is possible to actuate in three directions, i.e., the focus direction F, the track direction T, and the tilt direction Tir.

Unlike the above cases, when the same current is applied to the first and the third coils FC1 and FC3 and another same current is applied to the second and the fourth coils FC2 and FC4, if the phases of the two currents are different, the bobbin 15 can be actuated in a tangential tilt direction Tit.

When current with the same direction is applied to each of the four focus coils FC1, FC2, FC3, and FC4 independently, the bobbin 15 is moved up and down, thereby actuating in the focus direction F.

On the other hand, when currents having opposite directions are applied to the first and the second focus coils FC1 and FC2 and the third and the fourth focus coils FC3 and FC4, the bobbin 15 is actuated in a radial tilt direction Tir. Alternately, when currents having opposite directions are applied to the first and the third coils FC1 and FC3 and the second and the fourth coils FC2 and FC4, the bobbin is actuated in a tangential tilt direction Tit.

Also, the track coils TC1 and TC2 enable the bobbin 15 to move in the track direction by an interaction between the first polarization 22a and the second polarization 22b. Therefore, it is possible to actuate the bobbin 15 in four directions, i.e., the focus direction F, the track direction T, and the radial tilt direction Tir, and tangential tilt direction Tit.

To actuate the bobbin 15 in the focusing, tilt, and track directions, first through fourth supporting members 30a, 30b, 30c, and 30d are required. The four supporting members 30a, 30b, 30c, and 30d have uniform rigidity regardless of the actuating directions since they have a spiral shape.

In the above description, the focus coils combined use with the tilt coils and the track coils are disposed only on both of the sides 15a of the bobbin 15, however, according to another embodiment, the coils can also be disposed on four sides 15a and 15b of the bobbin 15.

Next, referring to FIG. 8, the interactions between the magnets and coils when the first through the fourth focus coils FC1, FC2, FC3, and FC4 and the first through the fourth tilt coils TiC1, TiC2, TiC3, and TiC4 are independently disposed on opposing sides 15a of the bobbin 15 will now be described.

The same current is applied to the first through the fourth focus coils FC1, FC2, FC3, and FC4. In this case, the bobbin 15 is simply moved up and down according to the direction of the current. Description regarding actuation of the track coils TC1 and TC2 will be omitted since it is the same as in the above description.

The bobbin 15 is actuated in the radial tilt direction Tir and in the tangential tilt direction Tit by applying current independently to each of the first through the fourth tilt coils TiC1, TiC2, TiC3, and TiC4. When the same current is applied to the first and the second tilt coils TiC1 and TiC2, and another same current having a different phase from the current applied to the first and the second tilt coils TiC1 and TiC2, is applied to the third and the fourth tilt coils TiC3 and TiC4, then a radial tilt direction Tir actuation is achieved. A tangential tilt direction Tit actuation is achieved by applying the same current to the first and the third tilt coils TiC1 and TiC3 and by applying the same current having a different phase from the current applied to the first and the third tilt coils TiC1 and TiC3, to the second and the fourth tilt coils TiC2 and TiC4.

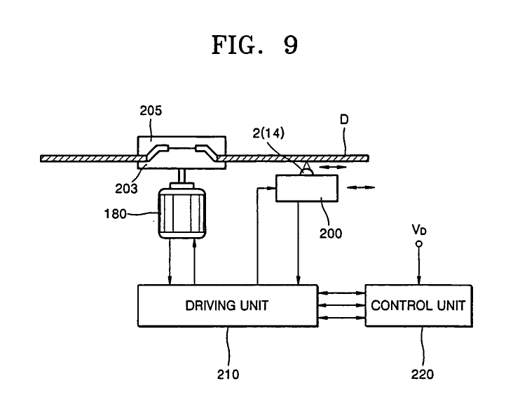

Referring to FIG. 9, an optical recording/reproducing apparatus that uses an optical pick-up actuator according to an embodiment of the present invention comprises a spindle motor 180 for rotating a disc D mounted on a turntable 203, and a clamping 205 facing the turntable 203 for chucking the disc D by an electromagnetic force caused by an interaction with the turntable 203. When the disc D is rotated by the spindle motor 180, an objective lens 2 (14) included in the optical pick-up device 200 reproduces information from the disc D or records information on the disc D by moving in a radial direction of the disc D.

To record and reproduce information on and from the disc D, the spindle motor 180 and the optical pick-up device 200 are driven by a driving unit 210, and a focus servo, a tilt servo, and a track servo of the optical pick-up device 200 are controlled by a control unit 220. The optical pick-up device 200 includes an optical part having an objective lens 2 (14) and an optical pick-up actuator for actuating the objective lens 2 (14) in the focus, tilt, and track directions.

A photoelectric transformation signal detected by the optical pick-up device 200 is inputted to the control unit 220 through the driving unit 210. The driving unit 210 controls a rotating speed of the spindle motor 180, amplifies the inputted signal, and drives the optical pick-up device 200. The control unit 220 generates a focus servo command, a tilt servo command, and a track servo command based on the focus signal, tilt signal, and track signal inputted from the driving unit 210, and sends the focus servo command, the tilt servo command, and the track servo command to the driving unit 210 to perform the focus servo, the tilt servo, and the track servo.

The optical pick-up device 200 employs an optical pick-up actuator according to an embodiment of the present invention. As is depicted in FIG. 3, it is an aspect of the present invention that the optical pick-up actuator includes a plurality of supporting members 8 disposed between the holder 6 and the bobbin 5.

The supporting members 8 include at least one wire pattern, thereby reducing the number of supporting members 8, and can be applied to an actuator regardless of the structure of the magnetic actuating unit, that is, the supporting members 8 can be applied both to a symmetrical actuator and an asymmetrical actuator.

The supporting members 8 have wire patterns that can reduce the number of supporting members, and have a spiral shape to exert a uniform rigidity in all actuating directions.

The optical pick-up actuator that includes supporting member according to embodiments of the present invention and the optical recording and reproducing apparatus using the optical pick-up actuator can be fabricated with reduced labor cost and failure rate, and increased yield. The supporting members according to embodiments of the present invention can effectively be applied to a slim optical pick-up actuator, and a variety of actuators, regardless of the structure of the actuator.

Although a few embodiments of the present invention have been shown and described, it would be appreciated by those skilled in the art that changes may be made in these embodiments without departing from the principles and spirit of the invention, the scope of which is defined in the claims and their equivalents.

1. A supporting member that supports a bobbin on which an objective lens is mounted, the supporting member having a wire pattern to apply a current.

2. The supporting member of claim 1, wherein the wire pattern is made of PCB.

3. The supporting member of claim 1, wherein the supporting member has a spiral shape.

4. An optical pick-up actuator actuating a bobbin, on which an objective lens is mounted, by a magnetic driving unit, wherein the bobbin is suspended by a plurality of supporting members, each supporting member having a wire pattern to apply a current.

5. The optical pick-up actuator of claim 4, wherein each supporting member has a spiral shape.

6. The optical pick-up actuator of claim 4, wherein the wire pattern is made of PCB.

7. An optical recording and reproducing apparatus that records and/or reproduces information on and/or from an optical disc by moving a bobbin on which an objective lens is mounted with respect to the optical disc, wherein the bobbin is suspended by a plurality of supporting members, each supporting member having a wire pattern to apply a current.

8. The optical recording and reproducing apparatus of claim 7, wherein each supporting member has a spiral shape.

9. The optical recording/reproducing apparatus of claim 7, wherein the wire pattern is made of PCB.

10. A supporting member connecting a holder and a bobbin that supports an objective lens, the bobbin being actuated by a magnetic actuator, and the supporting member having at least one wire pattern to supply current.

11. An optical pick-up actuator, comprising:
a base;
a holder connected with the base;
a bobbin;
an objective lens mounted on the bobbin;
a supporting member connecting the holder and the bobbin, and having at least one wire pattern having a spiral shape to supply current; and
a magnetic driving unit actuating the bobbin in a track direction, a focusing direction, and a tilt direction.

12. The optical pick-up actuator according to claim 11, wherein:
a (+) focusing wire F(+) and a (−) focusing wire F(−) are formed into one supporting member;
a (+) tracking wire T(+) and a (−) tracking wire T(−) are formed into one supporting member; and
a (+) tilt wire t(+) and a (−) tilt wire t(−) are formed into one supporting member.

13. The optical pick-up actuator according to claim 11, wherein:
the bobbin is suspended by a plurality of supporting members, each supporting member having at least one wire;
the magnetic driving unit comprises
at least one magnet connected with the base,
at least one track coil connected with the bobbin adjacent the magnet, to actuate the bobbin in the track direction, and
at least one focus coil connected with the bobbin adjacent the magnet, to actuate the bobbin in the focus direction; and
the wires of the supporting members supply current to the coils.

14. The optical pick-up actuator according to claim 11, wherein the magnetic driving unit further comprises at least one tilting coil connected with the bobbin adjacent the magnet, to actuate the bobbin in the tilt direction.

15. The optical pick-up actuator according to claim 13, wherein:
the at least one track coil comprises a plurality of track coils; and
the at least one focus coil comprises a plurality of focus coils, the plurality of focus coils actuating the bobbin in the focus and tilting directions.

16. The optical pick-up actuator according to claim 15, wherein:
the track coils and the focus coils are disposed on at least one of first opposing sides of the bobbin; and
the supporting members are connected with the bobbin on at least one of second opposing sides of the bobbin, the second opposing sides being adjacent the first opposing sides.

17. The optical pick-up actuator according to claim 11, wherein when six wires are required to actuate the bobbin in the focus, track, and tilt directions, a number of supporting members is at least two.

18. The optical pick-up actuator according to claim 17, wherein the number of supporting members is three.

19. The optical pick-up actuator according to claim 17, wherein when an additional two wires are required for a purpose other than actuating the bobbin in the focus, track, and tilt directions, the number of supporting members is at least three.
